(19) United States
(12) Patent Application Publication
(10) Pub. No.: US 2023/0054764 A1
(43) Pub. Date: Feb. 23, 2023

(54) ELECTROLYZED IMPINGEMENT CAVITATION REACTOR SYSTEM

(71) Applicant: MARAH HOLDINGS, LLC, Houston, TX (US)

(72) Inventor: Roland R. Pennington, JR., Houston, TX (US)

(21) Appl. No.: 17/499,311

(22) Filed: Oct. 12, 2021

Related U.S. Application Data
(60) Provisional application No. 63/235,870, filed on Aug. 23, 2021.

(51) Int. Cl. C02F 1/461; B01J 19/00; B01J 19/08

(52) U.S. Cl. CPC C02F 1/46109; B01J 19/0053; B01J 19/08; C02F 2001/46133; C02F 2001/46171; C02F 2201/46105; C02F 2201/002; B01J 2219/0877; B01J 2219/0807

(57) ABSTRACT

A method of electrolyzed impingement cavitation includes disposing a conductive rod at least partially within a lumen of a reactor pipe comprising a plurality of beveled perforations, disposing the conductive rod and the reactor pipe at least partially within a lumen of a reactor casing, electrically connecting a positive terminal of a direct current voltage source to the conductive rod, electrically connecting a negative terminal of the direct current voltage source to the reactor pipe, the reactor casing, or both, and applying a direct current to the conductive rod while fluidly communicating fluids into the lumen of the reactor pipe. The fluids are directed out of the plurality of beveled perforations forming enhanced cavitation bubbles that impinge an inner surface of the reactor casing while in at least part of an electrolysis reaction. Fluids are discharged from an annulus between the reactor pipe and the reactor casing.

### CROSS-REFERENCE TO RELATED APPLICATIONS

This application claims the benefit of, or priority to, U.S. Provisional Patent Application Ser. No. 63/235,870, filed on Aug. 23, 2021, which is hereby incorporated by reference in its entirety for all purposes.

### BACKGROUND OF THE INVENTION

The abundance of liquid water is one of the unique features that sustains life on our planet. While the origin of this water remains unknown, the vast majority of it is presently found in oceans that account for more than 96.5% of the planet's water supply by volume. While voluminous, ocean water contains a significant amount of dissolved salts, up to 35,000 parts-per-million (“ppm”) or more, and is not suitable for critical life-sustaining purposes. In addition, there is a significant volume of groundwater, approximately 1% of the planet's water supply by volume, that is also contaminated by salts.

The remainder of the planet's water supply, a mere 2.5% by volume, is found in freshwater sources that typically include less than 1,000 ppm of salt. Freshwater is critically important to the survival of living organisms and is therefore of great importance. Freshwater is found primarily in glaciers, ice caps, and groundwater sources. However, most water used for life-sustaining purposes is found in surface-based freshwater sources including ground ice, permafrost, lakes, rivers, swamps, marshes, and soil. While freshwater locked up in ice and the ground represent the majority of surface freshwater, they are very difficult to access. As such, accessible surface freshwater sources that sustain us constitute a mere fraction of a single percent of the planet's water supply by volume.

Given the vast volume of liquid water on our planet, the public has failed to recognize that we are facing a very serious water shortage, or more accurately stated, a very serious freshwater shortage. Simply put, consumption and use are draining freshwater sources faster than they are being replenished. Population growth, rising temperatures, and increased demand for agricultural irrigation have and continue to stress global reserves. In fact, the majority of the major aquifers are receding and the water table is dropping all over the world. Worse still, it is estimated that one quarter of the human population does not presently have access to safe drinking water. As such, critically important freshwater is a scarce resource that is becoming even more scarce with each passing year.

### BRIEF SUMMARY OF THE INVENTION

According to one aspect of one or more embodiments of the present invention, a method of electrolyzed impingement cavitation includes disposing a conductive rod at least partially within a lumen of a reactor pipe having a plurality of beveled perforations, disposing the conductive rod and the reactor pipe at least partially within a lumen of a reactor casing, electrically connecting a positive terminal of a direct current (“DC”) voltage source to the conductive rod, electrically connecting a negative terminal of the DC voltage source to the reactor pipe, the reactor casing, or both the reactor pipe and the reactor casing, and applying a direct current to the conductive rod while fluidly communicating fluids into the lumen of the reactor pipe. The fluids are directed out of the plurality of beveled perforations forming enhanced cavitation bubbles that impinge an inner surface of the reactor casing while in at least part of an electrolysis reaction. The treated fluids are discharged from an annulus formed between the reactor pipe and the reactor casing via a ported flange.

According to one aspect of one or more embodiments of the present invention, an electrolyzed impingement cavitation reactor system includes a reactor casing having a lumen that fluidly connects an inlet connection end to a discharge connection end. A reactor pipe includes a lumen that fluidly connects an inlet end to a removably sealed distal end and a plurality of beveled perforations disposed about the reactor pipe. The reactor pipe is at least partially disposed within the lumen of the reactor casing. An electrorod includes a conductive rod, a contact connector, and an electrical contact electrically connected to the conductive rod by the contact connector. The conductive rod is at least partially disposed within the lumen of the reactor pipe. A ported flange is disposed near the discharge connection end of the reactor casing and includes a plurality of discharge ports that fluidly discharge an annulus formed between the reactor pipe and the reactor casing. A positive terminal of a DC voltage source is electrically connected to the electrical contact and a negative terminal of the DC voltage source is electrically connected to the reactor pipe, the reactor casing, or both the reactor pipe and the reactor casing. A direct current is applied to the conductive rod while fluids are communicated into the lumen of the reactor pipe and through the beveled perforations of the reactor pipe creating enhanced cavitation bubbles that impinge on an inner surface of the reactor casing while in at least part of an electrolysis reaction. The treated fluids are discharged from an annulus formed between the reactor pipe and the reactor casing via the ported flange.

Other aspects of the present invention will be apparent from the following description and claims.

### BRIEF DESCRIPTION OF THE DRAWINGS

FIG. 1A shows an exploded front-facing perspective view of an electrorod of an electrolyzed impingement cavitation reactor system in accordance with one or more embodiments of the present invention.

FIG. 1B shows a front-facing perspective view of an electrorod of an electrolyzed impingement cavitation reactor system in accordance with one or more embodiments of the present invention.

FIG. 1C shows a rear-facing perspective view of an electrorod of an electrolyzed impingement cavitation reactor system in accordance with one or more embodiments of the present invention.

FIG. 1D shows a front elevation view of an electrorod of an electrolyzed impingement cavitation reactor system in accordance with one or more embodiments of the present invention.

FIG. 1E shows a rear elevation view of an electrorod of an electrolyzed impingement cavitation reactor system in accordance with one or more embodiments of the present invention.

FIG. 2A shows a front-facing perspective view of a reactor pipe of an electrolyzed impingement cavitation reactor system in accordance with one or more embodiments of the present invention.

FIG. 2B shows a rear-facing perspective view of a reactor pipe of an electrolyzed impingement cavitation reactor system in accordance with one or more embodiments of the present invention.

FIG. 2C shows a front elevation view of a reactor pipe of an electrolyzed impingement cavitation reactor system in accordance with one or more embodiments of the present invention.

FIG. 2D shows a rear elevation view of a reactor pipe of an electrolyzed impingement cavitation reactor system in accordance with one or more embodiments of the present invention.

FIG. 3A shows an exploded front-facing exploded view of an electrorod and a reactor pipe of an electrolyzed impingement cavitation reactor system in accordance with one or more embodiments of the present invention.

FIG. 3B shows a front-facing perspective view of an electrorod at least partially inserted into a reactor pipe of an electrolyzed impingement cavitation reactor system in accordance with one or more embodiments of the present invention.

FIG. 3C shows a rear-facing perspective view of an electrorod at least partially inserted into a reactor pipe of an electrolyzed impingement cavitation reactor system in accordance with one or more embodiments of the present invention.

FIG. 4A shows a front-facing perspective view of a reactor casing of an electrolyzed impingement cavitation reactor system in accordance with one or more embodiments of the present invention.

FIG. 4B shows a rear-facing perspective view of a reactor casing of an electrolyzed impingement cavitation reactor system in accordance with one or more embodiments of the present invention.

FIG. 4C shows a front elevation view of a reactor casing of an electrolyzed impingement cavitation reactor system in accordance with one or more embodiments of the present invention.

FIG. 4D shows a rear elevation view of a reactor casing of an electrolyzed impingement cavitation reactor system in accordance with one or more embodiments of the present invention.

FIG. 5 shows a front-facing perspective view of a slotted flange of an electrolyzed impingement cavitation reactor system in accordance with one or more embodiments of the present invention.

FIG. 6A shows an exploded front-facing perspective view of an electrorod, reactor pipe, and reactor casing of an electrolyzed impingement cavitation reactor system in accordance with one or more embodiments of the present invention.

FIG. 6B shows an exploded rear-facing perspective view of an electrorod, reactor pipe, and reactor casing of an electrolyzed impingement cavitation reactor system in accordance with one or more embodiments of the present invention.

FIG. 6C shows a front-facing perspective view of an assembled electrolyzed impingement cavitation reactor system in accordance with one or more embodiments of the present invention.

FIG. 6D shows a rear-facing perspective view of an assembled electrolyzed impingement cavitation reactor system in accordance with one or more embodiments of the present invention.

FIG. 6E shows a front elevation view of an assembled electrolyzed impingement cavitation reactor system in accordance with one or more embodiments of the present invention.

FIG. 6F shows a rear elevation view of an assembled electrolyzed impingement cavitation reactor system in accordance with one or more embodiments of the present invention.

FIG. 7A shows a rear-facing perspective view of a cross-section of an electrolyzed impingement cavitation reactor system in accordance with one or more embodiments of the present invention.

FIG. 7B shows a cross-sectional view of an electrolyzed impingement cavitation reactor system showing fluid flow paths in accordance with one or more embodiments of the present invention.

FIG. 7C shows a detailed cross-sectional view of electrolyzed impingement cavitation within an electrolyzed impingement cavitation reactor system in accordance with one or more embodiments of the present invention.

FIG. 8 shows an exploded front-facing perspective view of an electrolyzed impingement cavitation reactor system in accordance with one or more embodiments of the present invention.

### DETAILED DESCRIPTION OF THE INVENTION

One or more embodiments of the present invention are described in detail with reference to the accompanying figures. For consistency, like elements in the various figures are denoted by like reference numerals. In the following detailed description of the present invention, specific details are described to provide a thorough understanding of the present invention. In other instances, aspects that are well-known to those of ordinary skill in the art are not described to avoid obscuring the description of the present invention. For the purpose of this disclosure, reference to top, bottom, left, right, front, and rear are merely used to convey the relative position of various components to one another.

Because of the freshwater shortage and anticipated increase in demand without replenishment, many have looked to creative alternatives to alleviate the imbalance between supply and demand. Given the abundance of salt-laden ocean water, a common misperception is that desalination is a viable solution. Unfortunately, desalination is very expensive, requires a substantial amount of energy, and produces copious amounts of salt as a by-product. Given the cost as well as the economic and ecological impacts of desalination, it is, at present, a very expensive boutique solution that finds limited application in the most challenging environments. Another potential solution that is frequently discussed is rainwater capture. While rainfall capture is promising, it is only feasible in areas where there is sufficient rainfall and provides no solution for arid environments. While rainwater is fairly clean by most standards, it falls through the atmosphere, onto a catchment surface, and then into storage, where it is often contaminated by microbial, chemical, or particulate matter. As such, even in areas where there is sufficient rainfall, additional treatment of the captured rainwater is required for most life-sustaining uses. Notwithstanding, rainwater capture is not feasible in arid locations where water scarcity is most severe.

In view of the global freshwater shortage, receding aquifers, and lack of sufficient replenishment, focus has shifted to the treatment of contaminated water for consumer and commercial reuse. Contaminated water generally refers to water that includes at least some non-water material such as, for example, physical, chemical, biological, and/or radiological material. Contaminated water includes wastewater, produced water, and any other water containing non-water material. Wastewater generally refers to water contaminated by domestic or commercial use or as a by-product of industrial processes. Produced water generally refers to groundwater or water produced as part of oil and gas production that includes non-water contaminants. While the nature of the type and kind of contaminants can vary considerably from one type of contaminated water to another, common contaminants include, for example, nitrates, phosphates, minerals, heavy metals, pesticides, fertilizers, waste leached from landfills, municipal waste, and industrial waste discharge.

Common large-scale treatments for contaminated water includes coagulation and flocculation, sedimentation, filtration, disinfection, and distillation. The type or kind of treatment can vary from application to application based on the nature of the contamination profile and the intended use of the treated water. In some applications, multiple types or kinds of treatment may be used. While these treatment methods are effective, they require significant capital equipment that is expensive to procure, large in size, and expensive to operate such that they aren't feasible for mobile applications that require the treatment of large amounts of contaminated water at a more economical price point. As such, a longstanding need exists for a simple, efficient, scalable, mobile to treat contaminated water anywhere in the world in cost-effective manner.

Accordingly, in one or more embodiments of the present invention a method of, and system for, electrolyzed impingement cavitation enables treatment of contaminated water in a unique manner that is simple, efficient, scalable, mobile, and cost-effective such that it encourages widespread adoption and enables treatment of contaminated water in challenging environments. Electrolyzed impingement cavitation treats contaminated water through an enhanced impingement cavitation process that is further enhanced by performing the cavitation process at least partially within an electrolysis reaction. A plurality of beveled perforations disposed about the reactor pipe create enhanced cavitation bubbles that are directed to the reactor casing with high force to release a significant amount of energy upon contact. The collapse of the cavitation bubbles creates hydroxyl radicals that break down common water contaminants and oxidize the resulting elements. The supply of an electric current to the cavitating water stream creates an electrolysis reaction that enhances the cavitation process further. Three modes of grounding allow for the flexible configuration of the cathode, such that the electrolyzed enhancement of the impingement cavitation treatment can be varied by selection of a grounding scheme, where each scheme may further enhance impingement cavitation based on the types or kinds of contaminants in the water. Upon discharge from the reactor system to tankage, the cavitation process continues, non-water material settles at the bottom of the tank, and treated water may be separated from the contaminants for reuse. Advantageously, electrolyzed impingement cavitation reduces costs associated with treating contaminated water. The unique design of the electrolyzed impingement cavitation reactor system enables low-cost fabrication of the system. In addition, operation of the reactor system requires very little power and has no moving parts, thereby reducing ongoing operating and maintenance costs. In addition, an electrolyzed impingement cavitation reactor system may be disposed on a platform, skid, or trailer and be moveably disposed on site for use in practically any environment, anywhere in the world.

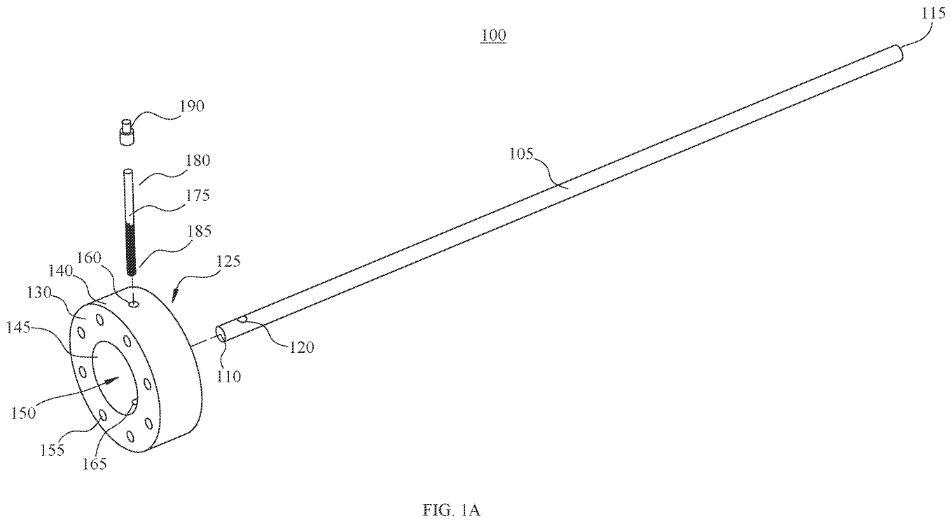

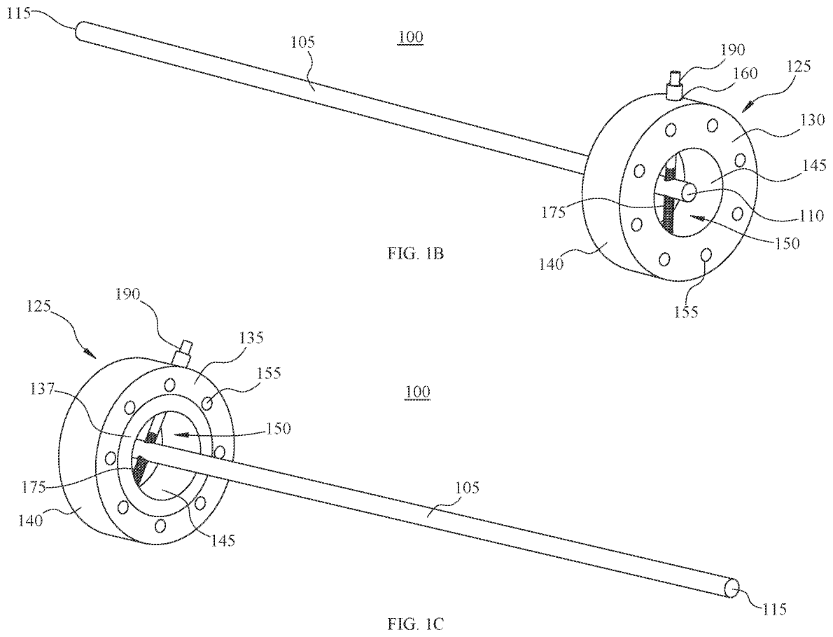

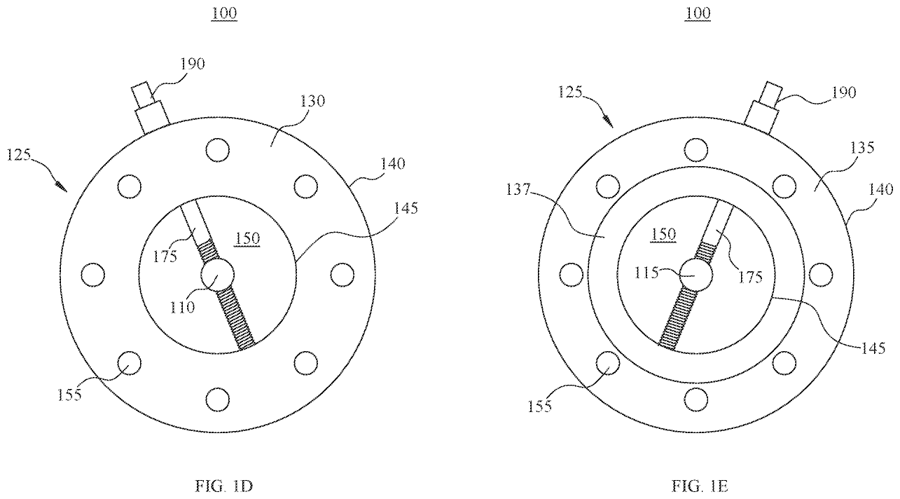

FIG. 1A shows an exploded front-facing perspective view of an electrorod 100 of an electrolyzed impingement cavitation reactor system (e.g., 600) in accordance with one or more embodiments of the present invention. In certain embodiments, electrorod 100 may include a conductive rod 105 that provides an electric current (not shown) to a cavitating water stream (not shown) as discussed herein. Conductive rod 105 may be a substantially cylindrical member having a material composition that is conductive. Conductive rod 105 may include a first distal end 110, a second distal end 115, and a threaded passthrough receiver 120. Because of its conductivity, there is electrical continuity and substantially no DC resistance from first distal end 110 of conductive rod 105 to second distal end 115 of conductive rod 105.

In certain embodiments, electrorod 100 may include a non-conductive spacer 125 that facilitates an electrical connection (e.g., 190) exterior to the casing of the reactor system (e.g., 600), electrically isolates first distal end 110 of conductive rod 105 from other components of the reactor system (e.g., 600), and positions first distal end 110 of conductive rod 105 within lumen 150 of non-conductive spacer 125. Non-conductive spacer 125 may be a substantially donut-shaped member having a material composition that is non-conductive. Non-conductive spacer 125 may include a first sidewall surface 130, a second sidewall surface (135, not shown in this view), an outer circumferential surface 140, an inner circumferential surface 145, a lumen 150, a plurality of mounting holes 155, a passthrough port 160 that connects outer circumferential surface 140 to inner circumferential surface 145, and a threaded receiver 165 formed in a portion of inner circumferential surface 145.

In certain embodiments, electrorod 100 may include a contact connector 175 to provide an electrical connection (e.g., 190) to conductive rod 105 that is disposed exterior to the casing (not shown) of the reactor system (e.g., 600). Contact connector 175 may be a substantially cylindrical member having a material composition that is conductive. A first distal end 185 of contact connector 175 may be disposed through passthrough port 160 of non-conductive spacer 125, threaded through threaded passthrough receiver 120 of conductive rod 105, and threaded into threaded receiver 165 of non-conductive spacer 125. At least a portion of contact connector 175 may be threaded. In this way, a threaded portion of contact connector 175 may form an interference fit with threaded passthrough receiver 120 of conductive rod 120 such that contact connector 175 is electrically connected to conductive rod 105 with electrical continuity and substantially no DC resistance. The first distal end 185 of contact connector 175 may also form a mechanical interference fit with threaded receiver 165 of non-conductive spacer 125 to secure contact receiver 175 in place to non-conductive spacer 125.

In certain embodiments, electrorod 100 may include an electrical contact 190 that provides an electrical connection between a DC voltage source (not shown) and contact connector 175. In certain embodiments, electrical contact 190 may be a welding connector. One of ordinary skill in the art will recognize that any other type or kind of electrical contact 190 suitable for making an electrical connection may be used in accordance with one or more embodiments of the present invention. A first end of electrical contact 190 may be electrically connected to a second distal end 180 of contact connector 175. A positive terminal (not shown) of the DC voltage source (not shown) may be electrically connected (not shown) to a second end of electrical contact 190 and therefore be electrically connected to contact connector 175 and conductive rod 105. In this way, conductive rod 105 may serve as an anode as part of an electrolysis reaction within the reactor system (e.g., 600) as discussed herein.

In certain embodiments, conductive rod 105 may be composed of copper or copper alloy. One of ordinary skill in the art will recognize that conductive rod 105 may composed of any conductive material, combination thereof, or alloy thereof capable of serving as an electrode in accordance with one or more embodiments of the present invention. In the embodiment depicted, conductive rod 105 may have a diameter of approximately 1.25 inches and may have a length of approximately 65 inches. However, one of ordinary skill in the art will recognize that the diameter and the length of conductive rod 105 may vary based on an application or design in accordance with one or more embodiments of the present invention. One of ordinary skill in the art will also recognize that the size, shape, and disposition of conductive rod 105 may vary based on the relationship of it, in its capacity as anode, to the cathode (not shown) of the reactor system (e.g., 600) as discussed herein.

In certain embodiments, non-conductive spacer 125 may be composed of acrylic. One of ordinary skill in the art will recognize that non-conductive spacer 125 may composed of other non-conductive material in accordance with one or more embodiments of the present invention. In the embodiment depicted, non-conductive spacer 125 may have an outer diameter of approximately 12 inches, an inner diameter, corresponding to lumen 150, of approximately 6 inches, and a thickness from first sidewall surface 130 to second sidewall surface 135 of approximately 4 inches. However, one of ordinary skill in the art will recognize that the outer diameter, inner diameter, and thickness of non-conductive spacer 125 may vary based on an application or design in accordance with one or more embodiments of the present invention.

In certain embodiments, contact connector 175 may be composed of copper or copper alloy. One of ordinary skill in the art will recognize that contact connector 175 may composed of any conductive material, combination thereof, or alloy thereof capable of serving as an electrical connection in accordance with one or more embodiments of the present invention. In the embodiment depicted, contact connector 175 may have a diameter of approximately ⅝ inches and may have a length of approximately 14 inches. However, one of ordinary skill in the art will recognize that the diameter and the length of contact connector 175 may vary based on an application or design in accordance with one or more embodiments of the present invention.

Continuing, FIG. 1B shows a front-facing perspective view of an electrorod 100 of an electrolyzed impingement cavitation reactor system (e.g., 600) in accordance with one or more embodiments of the present invention. In this view, the positioning of first distal end 110 of conductive rod 105 relative to non-conductive spacer 125, is shown. As discussed herein, the inlet for contaminated water (not shown) into the reactor system (e.g., 600) shall be through lumen 150. In addition, in this view, the interference fit between contact connector 175 and conductive rod 105 as well as the interference fit between the first distal end (e.g., 185) of contact connector 175 and non-conductive spacer 125 is shown. Continuing, FIG. 1C shows a rear-facing perspective view of an electrorod 100 of an electrolyzed impingement cavitation reactor system (e.g., 600) in accordance with one or more embodiments of the present invention. Second sidewall surface 135 of non-conductive spacer 125 may include a gasket interface 137 for a gasket (not shown). Continuing, FIG. 1D shows a front elevation view of an electrorod 100 of an electrolyzed impingement cavitation reactor system (e.g., 600) in accordance with one or more embodiments of the present invention. In this front elevation view, lumen 150 is more clearly shown. As discussed herein, the inlet flow path of contaminated water is through lumen 150. Continuing, FIG. 1E shows a rear elevation view of an electrorod 100 of an electrolyzed impingement cavitation reactor system (e.g., 600) in accordance with one or more embodiments of the present invention.

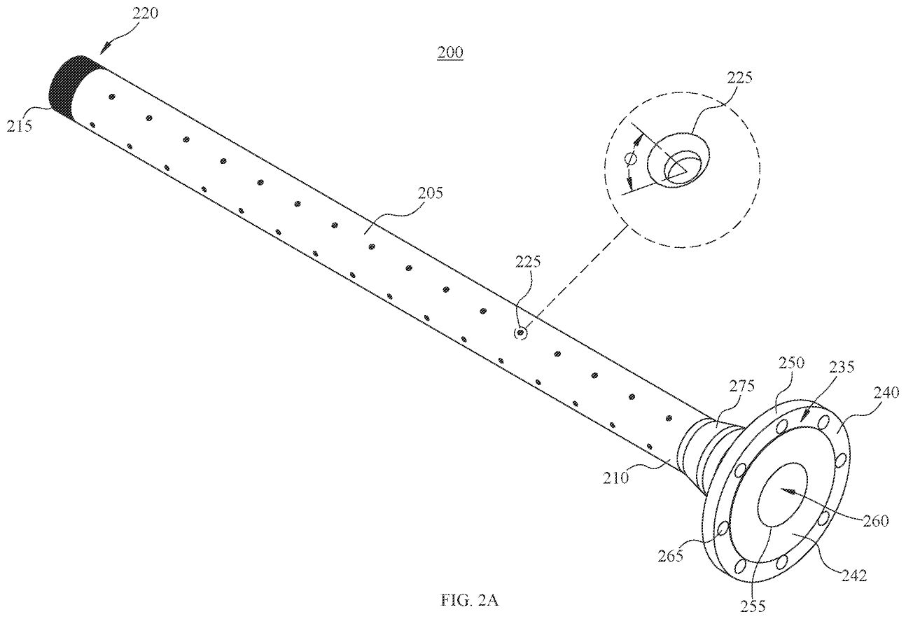

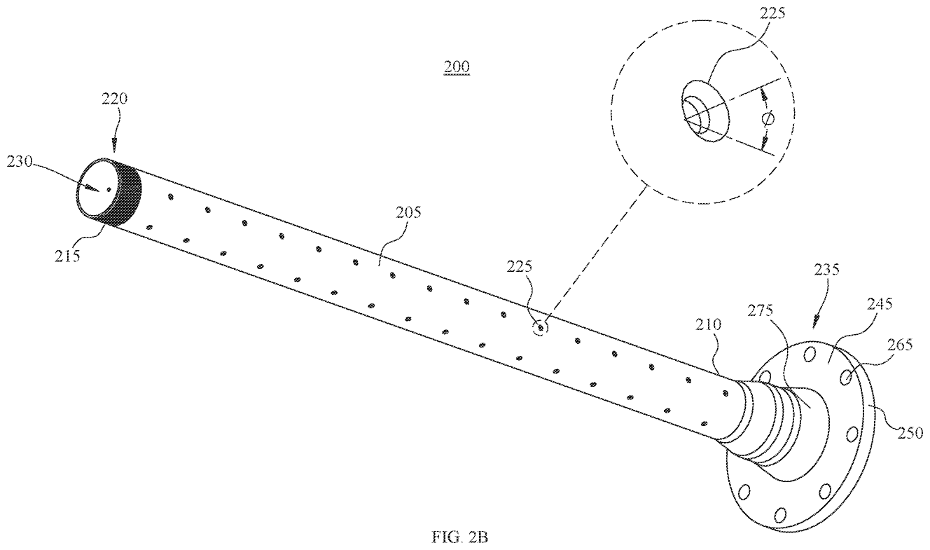

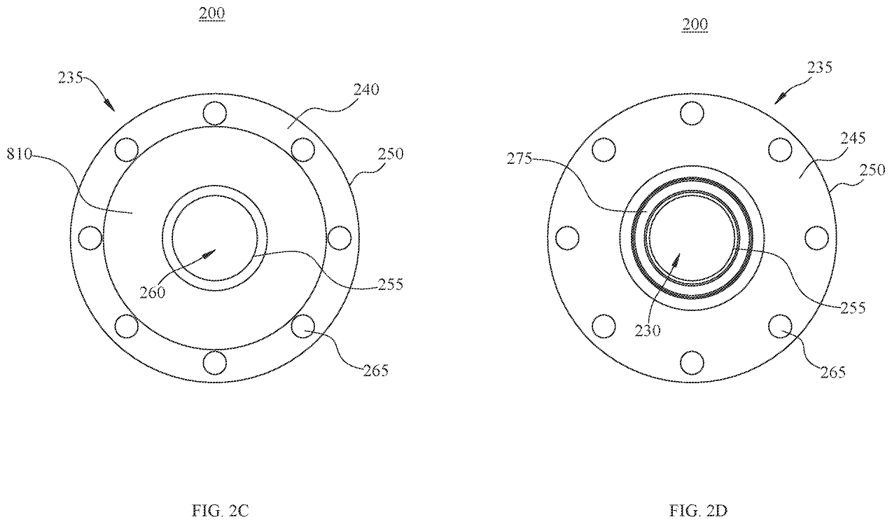

FIG. 2A shows a front-facing perspective view of a reactor pipe 200 of an electrolyzed impingement cavitation reactor system (e.g., 600) in accordance with one or more embodiments of the present invention. In certain embodiments, reactor pipe 200 may receive at least a portion of a conductive rod (e.g., 105) through lumen 260. Fluids (not shown) may flow into perforated pipe member 205 via lumen 260 and out through a plurality of beveled perforations 225 that create enhanced cavitation bubbles (not shown) as discussed herein. Perforated pipe member 205 may be a substantially cylindrical member having a first distal end 210 that is fluidly connected to a removably sealed second distal end 220 and a plurality of beveled perforations 225 disposed about member 205. Perforated pipe member 205 may include exterior threading 215 near second distal end 220 to receive a removably attached threaded cap (not shown) to force fluid flow from first distal end 210 into the lumen (230, not shown in this view) of perforated pipe member 205 and out through the plurality of beveled perforations 225 of member 205. As such, the plurality of beveled perforations 225 fluidly connect the lumen (230, not shown in this view) of perforated pipe member 205 with the annulus formed between perforated pipe member 205 of reactor pipe 200 and the casing pipe member (not shown) of the reactor casing (not shown).

The plurality of beveled perforations 225 may be disposed about and along perforated pipe member 205 of reactor pipe 200. In certain embodiments, the plurality of beveled perforations 225 may be in a column pattern disposed about and along the longitudinal length of perforated pipe member 205. In other embodiments, the plurality of beveled perforations 225 may be in an offset column pattern (not shown), where alternating columns are offset, disposed about and along the longitudinal length of perforated pipe member 205. In still other embodiments, the plurality of beveled perforations 225 may be in a serpentine pattern (not shown) disposed about and along the longitudinal length of perforated pipe member 205. In the embodiment depicted, the column pattern of beveled perforations 225 ensures that the enhanced cavitation bubbles impinge on the inner surface (not shown) of the casing pipe member (not shown) of the reactor casing (not shown) near to the respective beveled perforation 225. Notwithstanding, one of ordinary skill in the art will recognize that the pattern of beveled perforations 225 may vary based on an application or design in accordance with one or more embodiments of the present invention.

The beveled face of the plurality of beveled perforations 225 increase the size of enhanced cavitation bubbles (not shown), which correspondingly increases the amount of energy released upon impingement of the cavitation bubbles in the reactor system (e.g., 600). In certain embodiments, the exterior facing portion of beveled perforations 225 may have a bevel angle, φ, in a range between 5 degrees and 85 degrees. In other embodiments, the exterior facing portion of beveled perforations 225 may have a bevel angle, φ, in a range between 25 degrees and 65 degrees. In still other embodiments, the exterior facing portion of beveled perforations 225 have a bevel angle, φ, in a range between 40 degrees and 50 degrees. One of ordinary skill in the art will recognize that the size, shape, and pattern of the plurality of beveled perforations 225, as well as the bevel angle, may vary based on an application or design in accordance with one or more embodiments of the present invention.

In certain embodiments, flange 235 may include a first sidewall surface 240, a second sidewall surface (245, not shown in this view), an outer circumferential surface 250, an inner circumferential surface 255, a lumen 260, and a plurality of mounting holes 265. Because flange 235 may have an inner diameter corresponding to lumen 260 that may be a different size than an inner diameter corresponding to the lumen (230, not shown in this view) of perforated pipe member 205, a concentric reducer 275 may fluidly connect flange 235 to perforated pipe member 205 and fluidly reduce the inner diameter of lumen 260 to that of the lumen (230, not shown in this view) of perforated pipe member 205.

In certain embodiments, perforated pipe member 205 may be composed of stainless steel. In other embodiments, perforated pipe member 205 may be composed of steel. In still other embodiments, perforated pipe member 205 may be composed of copper nickel alloy. One of ordinary skill in the art will recognize that the composition of perforated pipe member 205 may vary based on an application or design in accordance with one or more embodiments of the present invention. In the embodiment depicted, perforated pipe member 205 may have an outer diameter of approximately 3.5 inches, an inner diameter of approximately 3 inches, and a length of approximately 52 inches. However, one of ordinary skill in the art will recognize that the outer diameter, the inner diameter, and the length of perforated pipe member 205 may vary based on an application or design in accordance with one or more embodiments of the present invention.

In certain embodiments, flange 235 may be composed of stainless steel. One of ordinary skill in the art will recognize that the composition of flange 235 may vary based on an application or design in accordance with one or more embodiments of the present invention. In the embodiment depicted, flange 235 may have an outer diameter of approximately 6 inches and an inner diameter of approximately 4 inches. However, one of ordinary skill in the art will recognize that the outer diameter and the inner diameter of flange 235 may vary based on an application or design in accordance with one or more embodiments of the present invention.

Continuing, FIG. 2B shows a rear-facing perspective view of a reactor pipe of an electrolyzed impingement cavitation reactor system (e.g., 600) in accordance with one or more embodiments of the present invention. In this view, lumen 230 of perforated pipe member 205, second sidewall surface 245 of flange 235, and concentric reducer 275 are shown. Lumen 230 extends from first distal end 210 to second distal end 220 of perforated pipe member 205. Continuing, FIG. 2C shows a front elevation view of a reactor pipe 200 of an electrolyzed impingement cavitation reactor system (e.g., 600) in accordance with one or more embodiments of the present invention. In operative use, contaminated water will enter reactor pipe 200 via lumen 260 of flange 235 and is directed into lumen 230 of perforated pipe member 205. Continuing, FIG. 2D shows a rear elevation view of a reactor pipe 200 of an electrolyzed impingement cavitation reactor system (e.g., 600) in accordance with one or more embodiments of the present invention. In operative use, a threaded cap (not shown) may be removably attached to threaded exterior 215 of second distal end 220 of perforated pipe member 205. As such, contaminated water flowing into lumen 230 of perforated pipe member 205 may be directed out through the plurality of beveled perforations (e.g., 225).

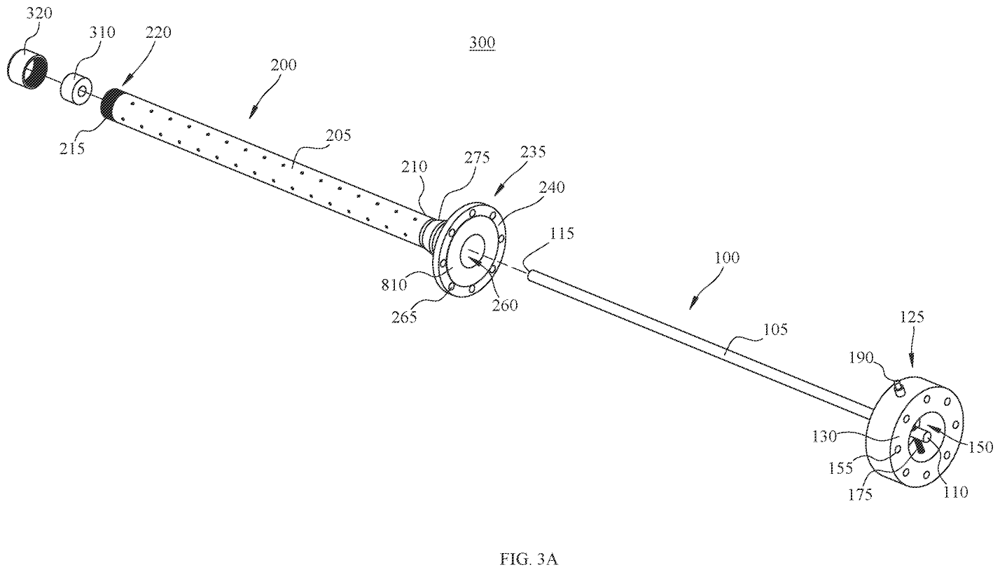

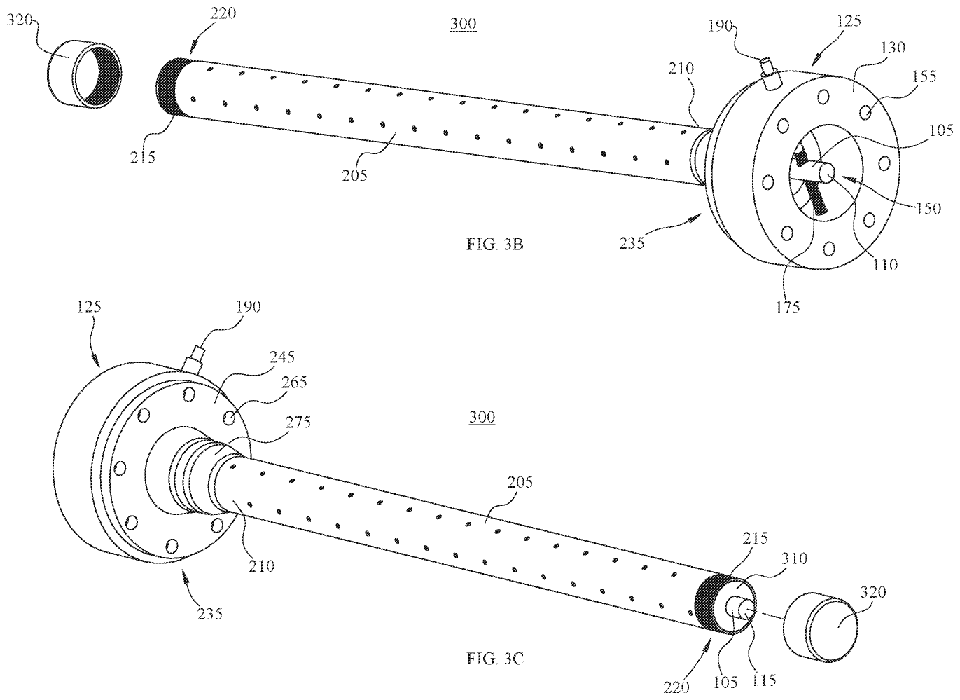

FIG. 3A shows an exploded front-facing exploded view of an electrorod 100 and a reactor pipe 200 of an electrolyzed impingement cavitation reactor system (e.g., 600) in accordance with one or more embodiments of the present invention. In assembly, second distal end 115 of conductive rod 105 of electrorod 100 may be at least partially disposed within the lumen (230, not shown) of perforated pipe member 205 of reactor pipe 200 (by way of lumen 260 of flange 235). A non-conductive spacer 315 may be used, in conjunction with non-conductive spacer 125, to position as well as electrically isolate conductive rod 105 of electrorod 100 from perforated pipe member 205 of reactor pipe 200. Non-conductive spacer 315 may have a substantially donut shape, an outer diameter slightly smaller than the lumen (230, not shown) of perforated pipe member 205, and an inner diameter large enough to receive at least a part of conductive rod 105. A backstop (not shown) may be placed on conductive rod 105 to prevent non-conductive spacer 315 from moving up conductive rod 105 towards first distal end 210.

Continuing, FIG. 3B shows a front-facing perspective view of an electrorod 100 at least partially inserted into a reactor pipe 200 of an electrolyzed impingement cavitation reactor system (e.g., 600) in accordance with one or more embodiments of the present invention. In this view, at least a portion of conductive rod 105 is disposed within perforated pipe member 205 and at least a portion of conductive rod 105 is disposed within non-conductive spacer 125. In certain embodiments, such as the one depicted, contact connector 175 serves a dual purpose of establishing electrical connectivity between electrical contact 190 and conductive rod 105 and also positions first distal end 110 of conductive rod 105 within, and secures first distal end 110 of conductive rod 105 to, non-conductive spacer 125 such that conductive rod 105 is electrically isolated from perforated pipe member 205 and flange 235 of reactor pipe 200. Continuing, FIG. 3C shows a rear-facing perspective view of an electrorod 100 at least partially inserted into a reactor pipe 200 of an electrolyzed impingement cavitation reactor system (e.g., 600) in accordance with one or more embodiments of the present invention. In this view, the placement of conductive rod 105 within perforated pipe member 205 is shown. During assembly, non-conductive spacer 310 may be slid onto conductive rod 105 and into perforated pipe member 205 until it is substantially flush with outer threaded portion 215 of perforated pipe member 205. A threaded cap 320 may, at a later time of assembly, be removably attached to outer threaded portion 215 of perforated pipe member 205.

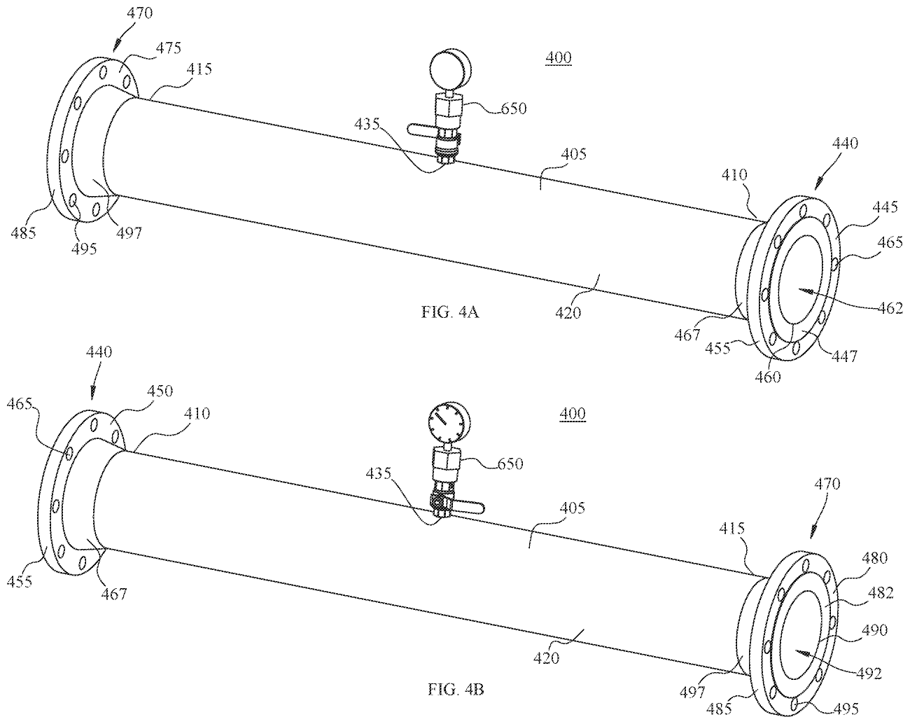

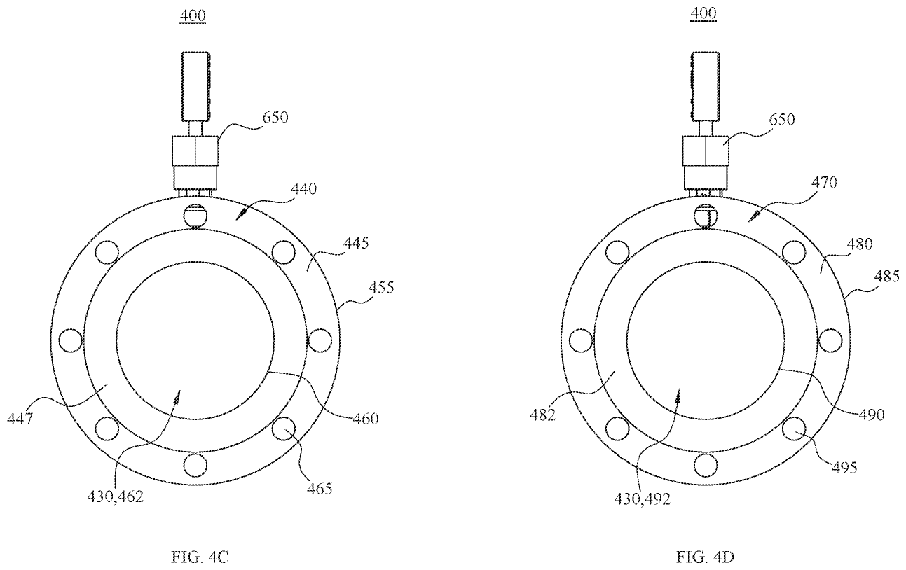

FIG. 4A shows a front-facing perspective view of a reactor casing 400 of an electrolyzed impingement cavitation reactor system (e.g., 600) in accordance with one or more embodiments of the present invention. Reactor casing 400 may receive at least a portion of the assembled (300, not shown) electrorod (100, not shown) and reactor pipe (200, not shown) forming an embodiment of an electrolyzed impingement cavitation reactor system (e.g., 600) as discussed herein. In certain embodiments, reactor casing 400 may include an inlet connection end 440, a pipe connection 467, casing pipe member 405, a second pipe connection 497, and a discharge connection end 470.

Casing pipe member 405 may include a first distal end 410 that is fluidly connected to a second distal end 415 by way of a lumen (430, not shown) that extends from lumen 462 of inlet connection end 440 through to the lumen (492, not shown) of discharge connection end 470. Casing pipe member 405 may include an outer circumferential surface 420, an inner circumferential surface (425, not shown), a lumen (430, not shown), and a gauge receiver 435 that extends from outer circumferential surface 420 through to inner circumferential surface (425, not shown) that may be used to receive a sensor such as, for example, a pressure gauge 650 that measures pressure within reactor casing 405. In certain embodiments, casing pipe member 405, in electrical continuity with inlet connection end 440 and discharge connection end 470, may serve as a cathode as part of an electrolysis reaction within the reactor system (e.g., 600) as discussed herein.

Inlet connection end 440 may include a first sidewall surface 445, a gasket receiver 447 formed in first sidewall receiver 445, a second sidewall surface (450, not shown), an outer circumferential surface 455, an inner circumferential surface 460, a lumen 462, and a plurality of mounting holes 465. Pipe connection 467 may be fixedly attached to inlet connection end 440. Discharge connection end 470 may include a first sidewall surface 475, a second sidewall surface (480, not shown), an outer circumferential surface 485, an inner circumferential surface 490, a lumen (492, not shown), and a plurality of mounting holes 495. Pipe connection 497 may be fixedly attached to discharge connection end 470.

Continuing, FIG. 4B shows a rear-facing perspective view of a reactor casing 400 of an electrolyzed impingement cavitation reactor system (e.g., 600) in accordance with one or more embodiments of the present invention. In this view, second sidewall surface 475 of inlet connection end 440 is shown. In addition, the connection between inlet connection end 440, pipe connection 467, and casing pipe member 405 is shown. Also in this view, second sidewall surface 480 of discharge connection end 470 is shown. Discharge connection end 470 may include a gasket receiver 482 formed in second sidewall surface 480. In addition, lumen 492 of discharge connection end 470 is shown. Continuing, FIG. 4C shows a front elevation view of a reactor casing 400 of an electrolyzed impingement cavitation reactor system (e.g., 600) in accordance with one or more embodiments of the present invention. In this view, lumen 430, 462 may be an inlet for contaminated water into a reactor system (e.g., 600). Continuing, FIG. 4D shows a rear elevation view of a reactor casing 400 of an electrolyzed impingement cavitation reactor system (e.g., 600) in accordance with one or more embodiments of the present invention. In this view, lumen 430, 492 may be a discharge outlet for treated water from a reactor system (e.g., 600).

In certain embodiments, reactor casing 400 may be composed of stainless steel. In other embodiments, reactor casing 400 may be composed of steel. In still other embodiments, reactor casing 400 may be composed of copper nickel alloy. One of ordinary skill in the art will recognize that reactor casing 400 may composed of any conductive material, combination thereof, or alloy thereof capable of serving as an electrode in accordance with one or more embodiments of the present invention. In the embodiment depicted, reactor casing 400 may have an outer diameter of approximately 6.625 inches (6″ nominal schedule STD), an inner diameter of approximately 6.065 inches, and a length of 54.55 inches. However, one of ordinary skill in the art will recognize that the outer diameter, the inner diameter, and the length of reactor casing 400 may vary based on an application or design in accordance with one or more embodiments of the present invention. One of ordinary skill in the art will also recognize that the size, shape, and disposition of reactor casing 400 may vary based on the relationship to the anode (not shown) of the reactor system (e.g., 600) as discussed herein.

In certain embodiments, inlet connection end 440 may be composed of stainless steel. One of ordinary skill in the art will recognize that the composition of inlet connection end 440 may vary based on an application or design in accordance with one or more embodiments of the present invention. In the embodiment depicted, inlet connection end 440 may be a flange having an outer diameter of approximately 12 inches (6″ American Society for Testing and Materials (“ASTM”) 150-pound raised face weld-neck stainless steel flange) and an inner diameter of approximately 6 inches. However, one of ordinary skill in the art will recognize that the outer diameter and the inner diameter of inlet connection end 440 may vary based on an application or design in accordance with one or more embodiments of the present invention.

In certain embodiments, discharge connection end 470 may be composed of stainless steel. One of ordinary skill in the art will recognize that the composition of discharge connection end 470 may vary based on an application or design in accordance with one or more embodiments of the present invention. In the embodiment depicted, discharge connection end 470 may be a flange having an outer diameter of approximately 12 inches (6″ ASTM 150-pound raised face weld-neck stainless steel flange) and an inner diameter of approximately 6 inches. However, one of ordinary skill in the art will recognize that the outer diameter and the inner diameter of discharge connection end 470 may vary based on an application or design in accordance with one or more embodiments of the present invention.

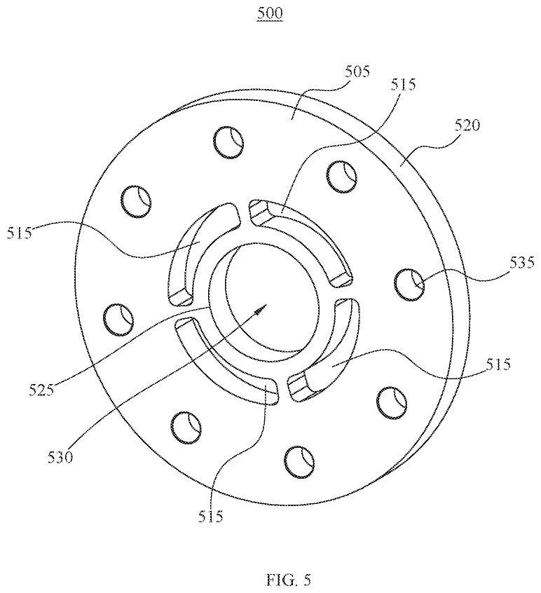

FIG. 5 shows a front-facing perspective view of a slotted flange 500 of an electrolyzed impingement cavitation reactor system (e.g., 600) in accordance with one or more embodiments of the present invention. Slotted flange 500 may be disposed near discharge connection end (470, not shown) of the reactor casing (400, not shown) to discharge treated fluids out of a reactor system (e.g., 600). Slotted flange 500 may be a substantially donut-shaped member with a first sidewall surface 505, a second sidewall surface (510, not shown), a plurality of discharge slots 515, an outer circumferential surface 520, an inner circumferential surface 525, a lumen 530, and a plurality of mounting holes 535. During assembly, slotted flange 500 may be placed near the discharge connection end (470, not shown) of the reactor casing (400, not shown). A portion of the electrorod (100, not shown) disposed within the reactor pipe (200, not shown) may be directed through lumen 530 as shown herein.

In certain embodiments, slotted flange 500 may be composed of stainless steel. One of ordinary skill in the art will recognize that the composition of slotted flange 500 may vary based on an application or design in accordance with one or more embodiments of the present invention. In the embodiment depicted, slotted flange 500 may have an outer diameter of approximately 12 inches and an inner diameter, corresponding to lumen 530, of approximately 3.5 inches. Discharge slots 515 may have a size and a shape to maximize throughput of discharged treated water. However, one of ordinary skill in the art will recognize that the outer diameter, the inner diameter, and the size, shape, and number of discharge slots 515 of slotted flange 500 may vary based on an application or design in accordance with one or more embodiments of the present invention.

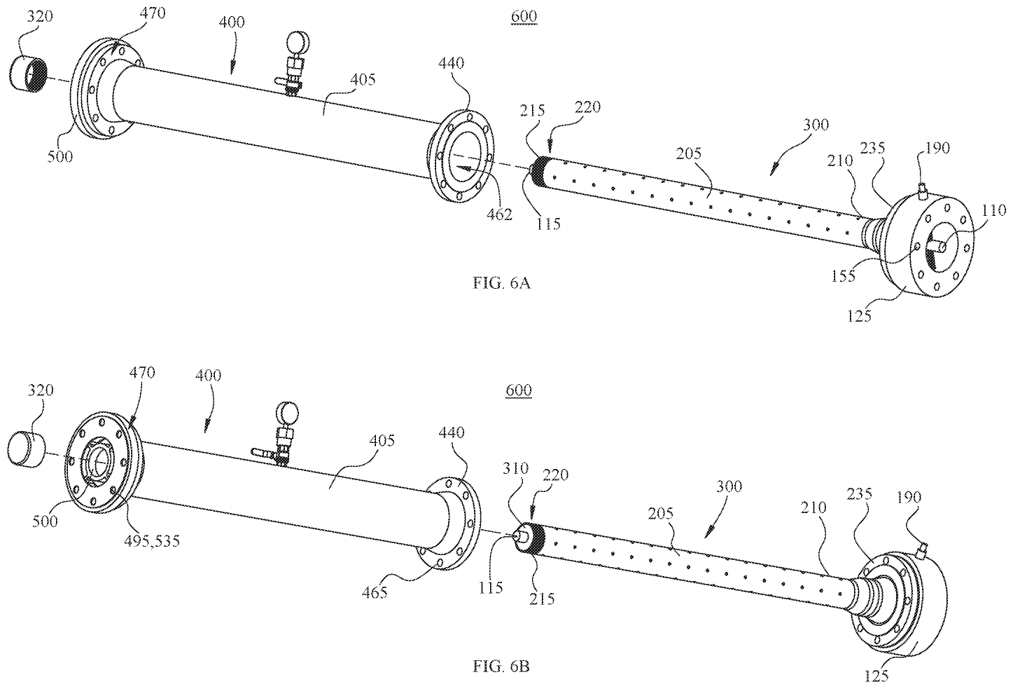

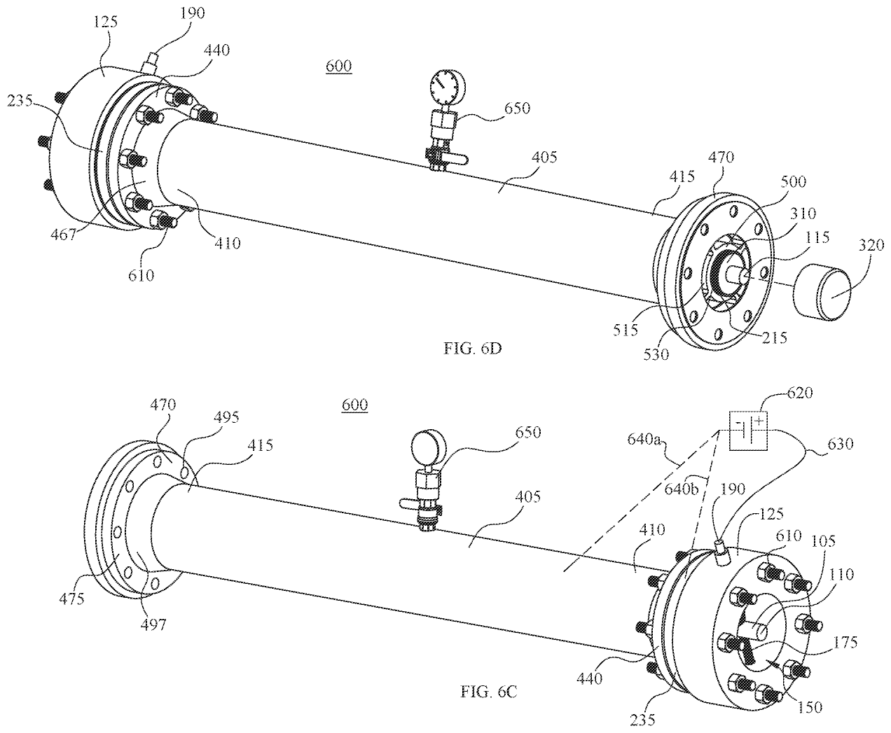

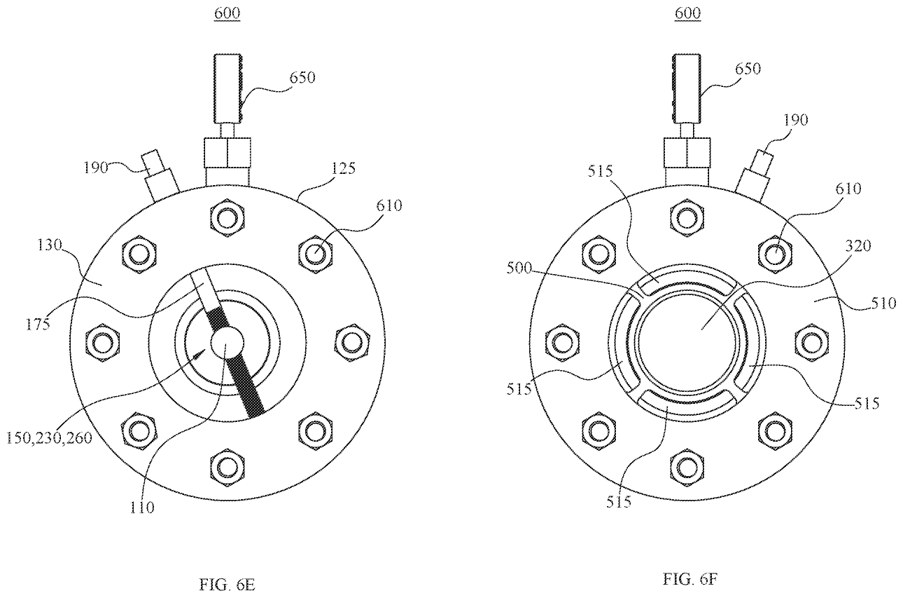

FIG. 6A shows an exploded front-facing perspective view of an electrorod 100 and a reactor pipe 200, collectively 300, and a reactor casing 400 of an electrolyzed impingement cavitation reactor system 600 in accordance with one or more embodiments of the present invention. The electrorod (100 of FIG. 3A) and the reactor pipe (200 of FIG. 3A) are partially assembled sub as shown in 300 of FIGS. 3B, 3C, and this FIG. 6A. Second distal end 220 of perforated pipe member 205 of sub 300 is inserted into lumen 462 of inlet connection end 440 of reactor casing 400 and through lumen (430, not shown) of casing pipe member 405 of reactor casing 400. Continuing, FIG. 6B shows an exploded rear-facing perspective view of an electrorod 100 and reactor pipe 200, collectively 300, and reactor casing 400 of an electrolyzed impingement cavitation reactor system 600 in accordance with one or more embodiments of the present invention. In this view, the placement of slotted flange 500 relative to discharge connection end 470 of reactor casing 400 is shown. The plurality of mounting holes 495 and 535 may be aligned to receive a mounting bolt and nut (not shown) used to secure the assembly in place.

Continuing, FIG. 6C shows a rear-facing perspective view of an assembled reactor system 600 in accordance with one or more embodiments of the present invention. Threaded portion 215 of the perforated pipe member (205, not independently labeled), may be at least partially disposed through lumen 492 of discharge connection end 470 of reactor casing 400 and lumen 530 of slotted flange 500. Threaded cap 320 may be removably attached to threaded end 215, thereby sealing off the second distal end (220, not labeled) of the perforated pipe member (205, not labeled). When threaded cap 320 is secured in place, discharge slots 515 may serve as the discharge outlet for treated water from reactor system 600 as discussed herein. In this view, a plurality of mounting bolts and nuts, collectively 610, may be disposed through aligned mounting holes 495 and 535 to secure the assembly in place. One of ordinary skill in the art, having the benefit of this disclosure, will recognize that reactor system 600 may be disposed in between a pumping system (not shown) at the inlet connection end 440 and a storage tank (not shown) at the discharge connection end 470. As such, the piping and connections used to secure reactor system 600 in place for operative use may vary based on the application or design in accordance with one or more embodiments of the present invention. As such, one of ordinary skill in the art will recognize that the plurality of mounting bolts and nuts 610 are merely exemplary and may be used to connect the inlet connection end 440 of reactor system 600 to an upstream pumping system (not shown) or feed for contaminated water.

Continuing, FIG. 6D shows a front-facing perspective view of an assembled electrolyzed impingement cavitation reactor system 600 in accordance with one or more embodiments of the present invention. As previously discussed, lumen 150 of non-conductive spacer 125 may serve as the inlet end for contaminated water into reactor system 600. A DC voltage source 620 may be used to apply a DC voltage to conductive rod 105 via electrical contact 190 and contact connector 175. As such, a positive terminal 630 of DC voltage source 630 may be electrically connected to electrical contact 190. In this way, as previously discussed, conductive rod 105 may serve as an anode in an electrolysis reaction.

In certain embodiments, when traditional mounting nuts and bolts 610 are used, flange 235 of reactor pipe 200 may be in electrical continuity with flange 440 of reactor casing 400. In such embodiments, a negative terminal 640a or 640b of DC voltage source 630 may be attached to a metal portion of reactor pipe 200 or reactor casing 400. In such cases, both reactor pipe 200 as well as reactor casing 400, jointly serve as a cathode in an electrolysis reaction. In such embodiments, impingement cavitation bubbles (not shown) are created, impinge, and release energy within a gradient of the cathode formed by reactor pipe 200 and reactor casing 400. In other embodiments, a negative terminal 640a of DC voltage source 630 may be attached reactor pipe 200 and electrically isolated from reactor casing 400 such that reactor pipe 200 alone acts as a cathode in an electrolysis reaction. In such embodiments, insulator material (not shown) may be strategically used, for example, along portions of the plurality of mounting bolts 610, to prevent shorting reactor pipe 200 to reactor casing 400. In still other embodiments, a negative terminal 640a of DC voltage source 630 may be attached reactor casing 400 and electrically isolated from reactor pipe 200 such that reactor casing 400 alone acts as a cathode in an electrolysis reaction. In such embodiments, insulator material (not shown) may be strategically used, for example, along portions of the plurality of mounting bolts 610, to prevent shorting reactor pipe 200 to reactor casing 400.

Continuing, FIG. 6E shows a front elevation view of an assembled electrolyzed impingement cavitation reactor system 600 in accordance with one or more embodiments of the present invention. In this view, the inlet connection end for contaminated water may be formed by the overlap of lumen 150 of non-conductive spacer 125, lumen 230 of perforated pipe member 205 of reactor pipe 200, and lumen 260 of flange 235 of reactor pipe 200. Continuing, FIG. 6F shows a rear elevation view of an assembled electrolyzed impingement cavitation reactor system 600 in accordance with one or more embodiments of the present invention. In this view, the discharge connection end for treated water is shown. When threaded cap 320 is removably attached to threaded end (215, not shown) of perforated pipe member 205 of reactor pipe 200, fluids in an annulus formed between perforated pipe member 205 of reactor pipe 200 and casing pipe member 405 of reactor casing 400 are discharged through the plurality of discharge slots 515 of slotted flange 500.

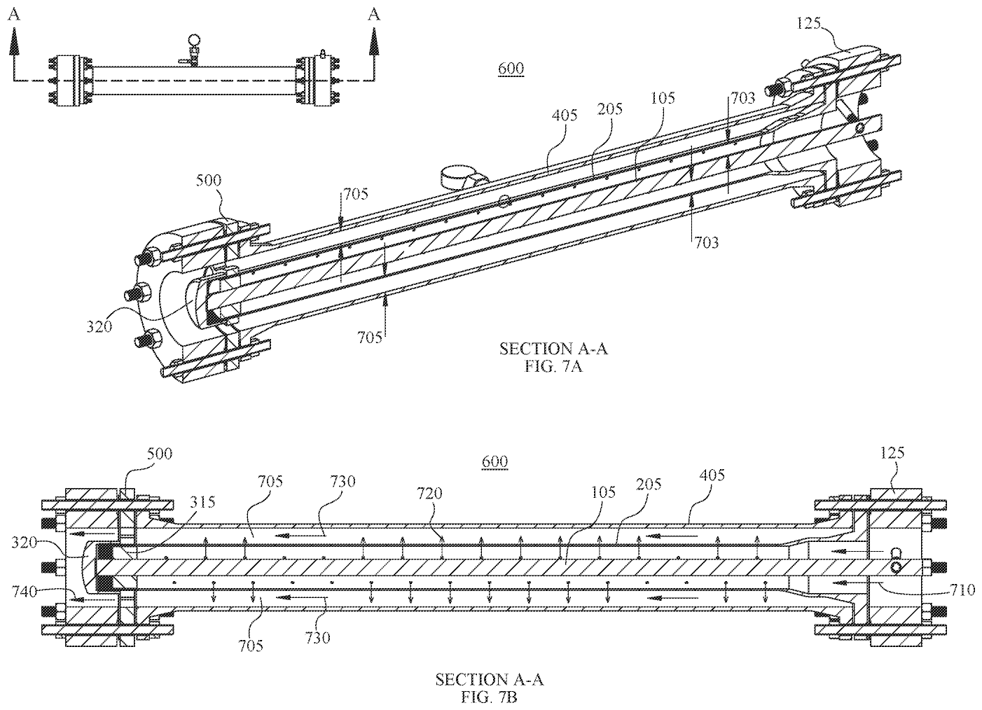

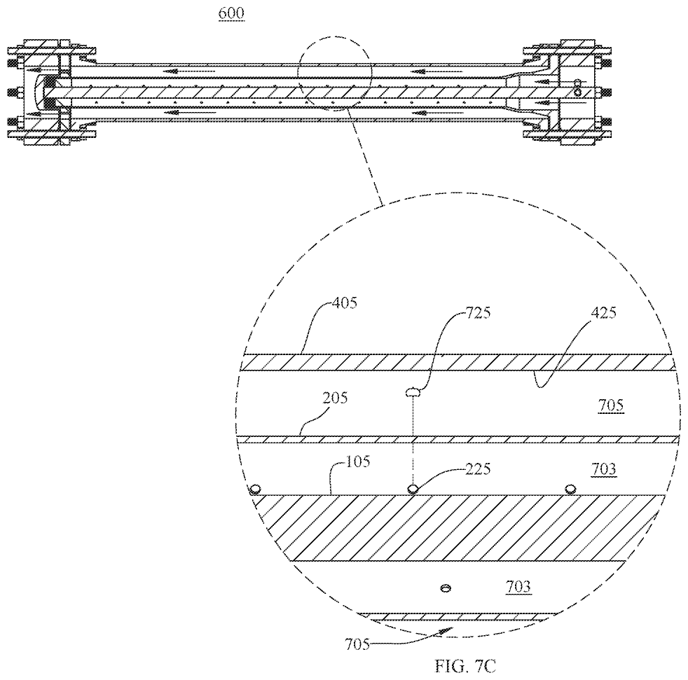

FIG. 7A shows a rear-facing perspective view of a cross-section of a reactor system 600 in accordance with one or more embodiments of the present invention. In cross-section, the relatively positioning of conductive rod 105 of electrorod 100, perforated pipe member 205 of reactor pipe 200, and casing pipe member 405 of reactor casing 400 are shown. Conductive rod 105 may be at least partially disposed within the lumen (230, not labeled) of perforated pipe member 205 of reactor pipe 200. Perforated pipe member 205 of reactor pipe 200 may be at least partially disposed within the lumen (430, not labeled) of reactor casing 400. An annulus 705 may be formed between perforated pipe member 205 of reactor pipe 200 and an inner surface of casing pipe member 405 of reactor casing 400. Continuing, FIG. 7B shows a cross-sectional view of an electrolyzed impingement cavitation reactor system 600 showing fluid flow paths in accordance with one or more embodiments of the present invention. Fluids 710 directed into the inlet connection and proceed into an annulus 703 formed between conductive rod 105 and an inner surface of perforated pipe member 405. Because threaded cap 320 seals the second distal end (220, not labeled) of perforated pipe member 405, annular 703 space fills and fluids 720 are directed out of the plurality of beveled perforations 225 of perforated pipe member 205 of reactor pipe 200. Under fluid pressure, the plurality of beveled perforations 225 form enhanced cavitation bubbles (not shown) that directly impinge against the inner surface of casing pipe member 405 of reactor casing 400 with high force. Treated fluids from annulus 705 are discharged out of the plurality of discharge slots 515 of slotted flange 500. While not shown, in typically applications, reactor system 600 may be disposed such that the discharge connection end 470 is fluidly connected to a storage tank (not shown). In storage, the electrolyzed impingement cavitation reaction may continue to further break down, oxidize, destroy, and settle contaminants such that treated water may be extracted for reuse.

Continuing, FIG. 7C shows a detailed cross-sectional view of electrolyzed impingement cavitation within an electrolyzed impingement cavitation reactor system 600 in accordance with one or more embodiments of the present invention. Fluids 710 flowing within perforated pipe member 205 of reactor pipe 200 are directed out of the plurality of perforations 225 forming enhanced cavitation bubbles 725 due to the static pressure of the fluids being less than the vapor pressure. As previously discussed, the beveled faces of the plurality of beveled perforations 225 increases the size of cavitation bubbles 725 formed. The increased size of cavitation bubbles 725, as well as their directed orientation relative to reactor casing 400 create enhanced impingement cavitation that releases a tremendous amount of energy upon impingement. The enhanced impingement cavitation generates reactive hydrogen atoms and hydroxyl radicals, some of which recombine to form hydrogen peroxide, that oxidize many contaminants, including complex organic chemicals and bio-refractory materials, present in contaminated water. While this type of cavitation may fall within the class of hydrodynamic cavitation, the reactor system 600 performs the enhanced impingement cavitation within a unique electrolysis reaction. As previously discussed, a positive terminal (630 of FIG. 6D) may be electrically connected to electrical contact 190. Since electrical contact 190 is in electrical continuity with conductive rod 105, a DC current may be directed along conductive rod 105, forming an anode. As previously discussed, reactor pipe 200 alone, reactor casing 400 alone, or both reactor pipe 200 and reactor casing 400 may be grounded with a negative terminal (640a or 640b of FIG. 6D), forming the cathode. The contaminated water may contain sufficient non-water material to constitute the electrolyte for an electrolysis reaction.

In certain embodiments, where the negative terminal (640a or 640b of FIG. 6D) is electrically connected to reactor pipe 200, and electrically isolated from reactor casing 400, the formation of enhanced cavitation bubbles 725 happens at the cathode, which supplies electrons to positively charged cations potentially flowing in the fluids toward the cathode, thereby enhancing the oxidation and destruction of contaminants in the water. In other embodiments, where the negative terminal (640a or 640b of FIG. 6D) is electrically connected to reactor casing 400, and electrically isolated from reactor pipe 200, the impingement of enhanced cavitation bubbles 725 happens at the cathode, which supplies electrons to positively charged cations potentially flowing in the fluids toward the cathode, thereby enhancing the oxidation and destruction of contaminants in the water. In still other embodiments where the negative terminal (640a or 640b of FIG. 6D) is electrically connected to both reactor pipe 200 and reactor casing 400, the formation of enhanced cavitation bubbles 725 and the impingement of the enhanced cavitation bubbles 725 happen in a cathode gradient of an electrolysis reaction, thereby enhancing the oxidation and destruction of contaminants in the water.

In one or more embodiments of the present invention, a fluid pressure may influence the effectiveness of electrolyzed impingement cavitation. In certain embodiments, the fluid pressure may be in a range between 15 pounds per square inch (“psi”) and 250 psi. In other embodiments, the fluid pressure may be in a range between 35 pounds per square inch psi and 175 psi. In still other embodiments, the fluid pressure may be in a range between 50 pounds per square inch psi and 100 psi. One of ordinary skill in the art will recognize that the pressure may be impacted by the scale and size of reactor system 600 and may vary based on an application or design in accordance with one or more embodiments of the present invention.

In one or more embodiments of the present invention, a DC voltage may influence the effectiveness of electrolyzed impingement cavitation. In certain embodiments, the DC voltage applied may be in a range between 110 volts DC and 220 volts DC. One of ordinary skill in the art will recognize that the DC voltage applied to the electrical contact 190 may vary based on an application or design in accordance with one or more embodiments of the present invention.

In one or more embodiments of the present invention, a DC current may influence the effectiveness of electrolyzed impingement cavitation. In certain embodiments, the DC current applied may be in a range between 5 amperes and 150 amperes. In other embodiments, the DC current applied may be in a range between 15 amperes and 75 amperes. In still other embodiments, the DC current applied may be in a range between 20 amperes and 30 amperes. One of ordinary skill in the art will recognize that the DC current applied to conductive rod 105 may vary based on an application or design in accordance with one or more embodiments of the present invention.

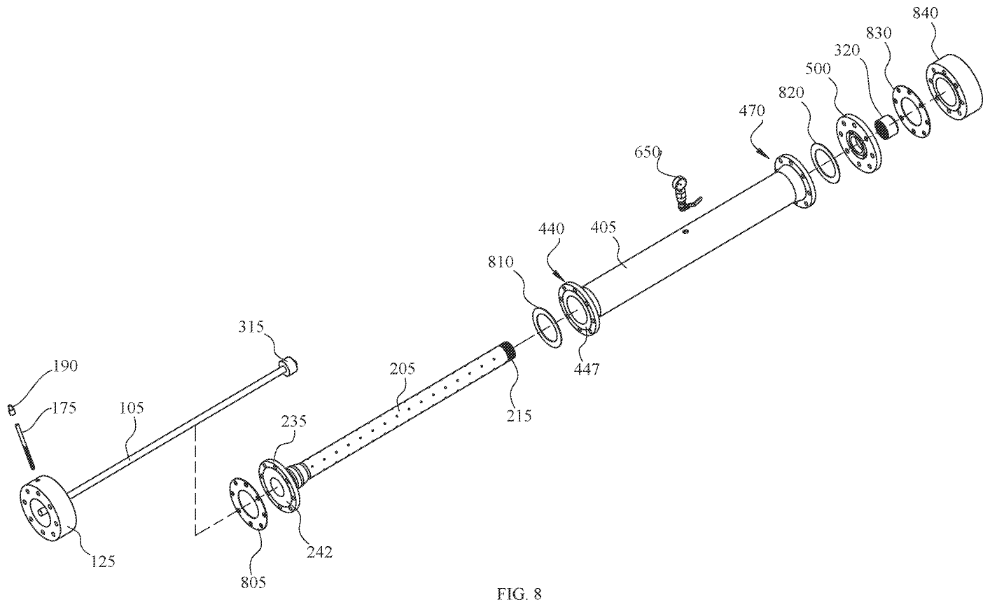

FIG. 8 shows an exploded front-facing perspective view of a reactor system 600 in accordance with one or more embodiments of the present invention. As previously discussed, at least a portion of conductive rod 105 may be disposed within a lumen 150 of non-conductive spacer 125. Contact connector 175 may be disposed through non-conductive spacer 125, through conductive rod 105, and partially into non-conductive spacer 125. Conductive rod 105 may be at least partially disposed within a lumen 230 of perforated pipe member 205 of reactor pipe 200. A gasket 805 may be disposed between non-conductive spacer 125 and flange 235 of reactor pipe 200. At least a portion of perforated pipe member 205 of reactor pipe 200 may be disposed within a lumen 430 of casing pipe member 405 of reactor casing 400. A gasket 810 may be disposed between flange 235 and inlet connection end 440 of reactor casing 400. A gasket 820 may be disposed between discharge connection end 470 and slotted flange 500. At least a portion of perforated pipe member 205 may be disposed through discharge connection end 470 and slotted flange 500. Threaded cap 320 may be removably attached to threaded portion 215 of reactor pipe 200. A gasket 830 may be disposed between slotted flange 500 and a non-conductive spacer 840. Non-conductive spacer 840 may electrically isolate reactor system 600 from downstream connections, such as, for example, a connection (not shown) to a storage tank (not shown).

On the inlet connection end 440, a plurality of mounting bolts and nuts may be used to secure non-conductive spacer 125 of electrorod 100, flange 235 of reactor pipe 200, and inlet connection end 440 of reactor casing 400 and potentially an upstream connection (not shown) together. While not shown, it is anticipated that, upstream of reactor system 600, a variable frequency drive (“VFD”) motor driven pumping system may be used to pump contaminated water into the inlet connection end of reactor system 600. In such cases, there may be additional components, such as an upstream connection (not shown), connected to non-conductive spacer 125, flange 235, and inlet connection end 440 prior to bolting.

Similarly, on the discharge connection end 470, a plurality of mounting bolts and nuts may be used to secure discharge connection end 470, slotted flange 500, and non-conductive spacer 840 and potentially a downstream connection (not shown) together. While not shown, it is anticipated that, downstream of reactor system 600, a storage tank may be used to allow the electrolyzed impingement cavitation reaction to continue to oxidize and destroy contaminates. In such cases, there may be additional components, such as downstream connectors (not shown), connected to discharge connection end 470, slotted flange 500, and non-conductive spacer 840 prior to bolting.

In one or more embodiments of the present invention, an electrolyzed impingement cavitation reactor system 600 may include a reactor casing 400 comprising a casing pipe member 405 having a lumen 430 that fluidly connects an inlet connection end 440 to a discharge connection end 470. Electrolyzed impingement cavitation reactor system 600 may include a reactor pipe 200 comprising a perforated pipe member 205 having a lumen 230 that fluidly connects an inlet end 235 to a removably sealed distal end 220 and a plurality of beveled perforations 225 disposed about perforated pipe member 205 of reactor pipe 200. Reactor pipe 200 may be at least partially disposed within lumen 430 of reactor casing 400. An electrorod 100 may include a conductive rod 105, a contact connector 175, and an electrical contact 190 electrically connected to conductive rod 105. Conductive rod 105 may be at least partially disposed within lumen 230 of perforated pipe member 205 of reactor pipe 200. A ported flange 500 may be disposed near the discharge connection end 470 and may include a plurality of discharge ports 515 that fluidly discharge an annulus 705 formed between perforated pipe member 205 of reactor pipe 200 and casing pipe member 405 of reactor casing 400.

A positive terminal 630 of a DC voltage source 620 may be electrically connected to electrical contact 190. A negative terminal 640a/640b of DC voltage source 620 may be electrically connected to reactor pipe 200, reactor casing 400, or both reactor pipe 200 and reactor casing 400 such that they are in electrical continuity and shorted together.

In certain embodiments, negative terminal 640b of DC voltage source 620 may be electrical connected to reactor pipe 200. In such embodiments, reactor pipe 200 may be electrically isolated from conductive rod 105 and reactor casing 400 and reactor pipe 200 alone may serve as a cathode to the electrolysis reaction.

In other embodiments, negative terminal 640a of DC voltage source 620 may be electrical connected to reactor casing 400. In such embodiments, reactor casing 400 may be electrically isolated from conductive rod 105 and reactor pipe 200 and reactor casing 400 alone may serve as a cathode to the electrolysis reaction.

In still other embodiments, negative terminal 640a of DC voltage source 620 may be electrical connected to reactor pipe 200 and reactor casing 400. In such embodiments, reactor pipe 200 and reactor casing 400 may be in electrical continuity such that there is substantially no DC resistance between them. In such cases, a cathode gradient may be formed between reactor pipe 200 and reactor casing 400 and the cavitating fluids disposed in annulus 705 formed between perforated pipe member 205 of reactor pipe 200 and casing pipe member 405 of reactor casing 400.

Fluids may be directed from the inlet end 235 of reactor pipe 200 through the plurality of beveled perforations 225 of perforated pipe member 205 of reactor pipe 200 creating enhanced cavitation bubbles 725 that impinge on an inner surface of casing pipe member 405 of reactor casing 400 while in at least part of an electrolysis reaction. The plurality of beveled perforations 225 may fluidly connect lumen 230 of perforated pipe member 205 of reactor pipe 200 with annulus 705 formed between perforated pipe member 205 of reactor pipe 200 and casing pipe member 405 of reactor casing 400. The enhanced cavitation bubbles 725 may be directed to collapse against an inner surface 425 of casing pipe member 405 of reactor casing 400 with high force to enhance cavitation.

In one or more embodiments of the present invention, a method of electrolyzed impingement cavitation may include disposing a conductive rod 105 at least partially within a lumen 230 of a perforated pipe member 205 of reactor pipe 200. Perforated pipe member 205 may have a plurality of beveled perforations 225 disposed about the longitudinal length of perforated pipe member 205. Conductive rod 105 and reactor pipe 200 may be at least partially disposed within lumen 430 of casing pipe member 405 of reactor casing 400.

A positive terminal 630 of a DC voltage source 620 may be electrically connected to electrical contact 190. A negative terminal 640a/640b of DC voltage source 620 may be electrically connected to reactor pipe 200, reactor casing 400, or both reactor pipe 200 and reactor casing 400 such that they are shorted together.

In certain embodiments, negative terminal 640b of DC voltage source 620 may be electrical connected to reactor pipe 200. In such embodiments, reactor pipe 200 may be electrically isolated from conductive rod 105 and reactor casing 400 and reactor pipe 200 alone may serve as a cathode to the electrolysis reaction.

In other embodiments, negative terminal 640a of DC voltage source 620 may be electrical connected to reactor casing 400. In such embodiments, reactor casing 400 may be electrically isolated from conductive rod 105 and reactor pipe 200 and reactor casing 400 alone may serve as a cathode to the electrolysis reaction.

In still other embodiments, negative terminal 640a of DC voltage source 620 may be electrical connected to reactor pipe 200 and reactor casing 400. In such embodiments, reactor pipe 200 and reactor casing 400 may be in electrical continuity such that there is substantially no DC resistance between them. In such cases, a cathode gradient may be formed between perforated pipe member 205 of reactor pipe 200 and casing pipe member 405 of reactor casing 400 and the cavitating fluids disposed in annulus 705 formed between perforated pipe member 205 of reactor pipe 200 and casing pipe member 405 of reactor casing 400.

A DC current may be applied to conductive rod 105 while fluidly communicating fluids into lumen 230 of perforated pipe member 205 of reactor pipe 200. The fluids may be directed into lumen 230 of perforated pipe member 205 and out through the plurality of beveled perforations 225 of perforated pipe member 205 of reactor pipe 200, forming enhanced cavitation bubbles 725 that impinge an inner surface of the casing pipe member 405 of reactor casing 400 while in at least part of an electrolysis reaction. The treated fluids may be discharged from an annulus 705 formed between perforated pipe member 205 of reactor pipe 200 and casing pipe member 405 of reactor casing 400.

One of ordinary skill in the art, having the benefit of this disclosure, will recognize that one or more non-transitory computer-readable media may comprise software instructions that, when executed by a processor, may perform one or more of the above-noted methods in accordance with one or more embodiments of the present invention.

Advantages of one or more embodiments of the present invention may include one or more of the following:

In one or more embodiments of the present invention, electrolyzed impingement cavitation enables treatment of contaminated water in an inexpensive, highly efficient, mobile, and scalable manner.

In one or more embodiments of the present invention, electrolyzed impingement cavitation treats contaminated water through an enhanced impingement cavitation process that at least partially takes place within a unique electrolysis reaction. A plurality of beveled perforations disposed about the reactor pipe create enhanced cavitation bubbles that are directed to the reactor casing with high force to release a significant amount of energy upon contact. The collapse of the cavitation bubbles creates hydroxyl radicals that allow common water contaminants to be broken down. The resulting elements are then broken down and oxidized. The supply of an electric current to the cavitating water stream enhances the process further. Three modes of grounding allow for the flexible configuration of the cathode, such that the electrolyzed enhancement of the impingement cavitation treatment can be varied by selection of a grounding scheme that enhances cavitation based on the contaminants in the water. Upon discharge from the reactor system to tankage, the cavitation process continues, and non-water material settles at the bottom of the tank such that treated water may be separated from the contaminants for reuse.

In one or more embodiments of the present invention, electrolyzed impingement cavitation treats contaminated water by creating enhanced cavitation bubbles that impinge on an inner surface of the reactor casing while simultaneously supplying a direct current to the cavitating water stream. The impingement portion of the cavitation process takes place, at least partially, within an electrolysis reaction that enhances separation of non-water material from water. Three different grounding schemes are disclosed that vary the disposition of the cathode and thereby impacts the electrolysis portion of the reaction. Certain configurations of the cathode may be more efficient at oxidizing and destroying contaminants than others.

In one or more embodiments of the present invention, electrolyzed impingement cavitation may use a conductive rod to supply a direct current to the cavitating water stream prior to the creation of enhanced cavitation bubbles. The design of the reactor pipe, beveled perforations, and reactor casing cause the enhanced cavitation bubbles to impinge on an inner surface of the reactor casing with high force and collapse prior to discharge from the reactor system.

In one or more embodiments of the present invention, electrolyzed impingement cavitation may use the conductive rod as the anode for the electrolysis reaction. In certain embodiments, the reactor pipe and the reactor casing may be grounded and serve as the cathode for the electrolysis reaction. In such embodiments, the creation and impingement of enhanced cavitation bubbles happens in a gradient of the cathode. In other embodiments, the reactor pipe may be electrically isolated from the reactor casing and the reactor pipe alone may be grounded to serve as the cathode for the electrolysis reaction. In still other embodiments, the reactor casing may be electrically isolated from the reactor pipe and the reactor casing alone may be grounded to serve as the cathode for the electrolysis reaction.

In one or more embodiments of the present invention, electrolyzed impingement cavitation reduces costs associated with treating contaminated water. The design of the electrolyzed impingement cavitation reactor system enables low-cost fabrication of the system. In addition, operation of the reactor system requires very little power and has no moving parts, thereby reducing ongoing operating and maintenance costs.

In one or more embodiments of the present invention, electrolyzed impingement cavitation provides a mobile solution to treat contaminated water. The electrolyzed impingement cavitation reactor system may be moveably disposed on site or moveably disposed on a skid or truck for use in practically any environment.

In one or more embodiments of the present invention, electrolyzed impingement cavitation provides a simple, efficient, and cost-effective method to treat contaminated water that enables widespread adoption and use.

While the present invention has been described with respect to the above-noted embodiments, those skilled in the art, having the benefit of this disclosure, will recognize that other embodiments may be devised that are within the scope of the invention as disclosed herein. Accordingly, the scope of the invention should only be limited by the appended claims.

What is claimed is:

1. An electrolyzed impingement cavitation reactor system comprising:
a reactor casing comprising a lumen that fluidly connects an inlet connection end to a discharge connection end;
a reactor pipe comprising a lumen that fluidly connects an inlet end to a removably sealed distal end and a plurality of beveled perforations disposed about the reactor pipe, wherein the reactor pipe is at least partially disposed within the lumen of the reactor casing;
an electrorod comprising a conductive rod and a contact electrically connected to the conductive rod, wherein the conductive rod is at least partially disposed within the lumen of the reactor pipe; and
a ported flange comprising a plurality of discharge ports that fluidly discharge an annulus formed between the reactor pipe and the reactor casing,
wherein a positive terminal of a direct current voltage source is electrically connected to the contact and a negative terminal of the direct current voltage source is electrically connected to the reactor pipe, the reactor casing, or both, and
wherein fluids are directed from the inlet end of the reactor pipe through the beveled perforations of the reactor pipe creating enhanced cavitation bubbles that impinge on an inner surface of the reactor casing while in at least part of an electrolysis reaction.

2. The system of claim 1, wherein the beveled perforations fluidly connect the lumen of the reactor pipe with the annulus formed between the reactor pipe and the reactor casing.

3. The system of claim 1, wherein the beveled perforations have an outer face with a bevel in a range between 40 degrees and 50 degrees to enhance cavitation.

4. The system of claim 1, wherein the enhanced cavitation bubbles are directed to collapse against an inner surface of the reactor casing with high force to enhance cavitation.

5. The system of claim 1, wherein the conductive rod is electrically isolated from the reactor pipe and the reactor casing and is an anode to the electrolysis reaction.

6. The system of claim 1, wherein the direct current voltage source has a voltage in a range between 110 volts and 220 volts.

7. The system of claim 1, wherein the direct current voltage source provides direct current to a cavitating fluids in a range between 20 amperes and 30 amperes.

8. The system of claim 1, wherein the negative terminal of the direct current voltage source is electrical connected to the reactor pipe, the reactor pipe is electrically isolated from the reactor casing and the conductive rod, and the reactor pipe is a cathode to the electrolysis reaction.

9. The system of claim 1, wherein the negative terminal of the direct current voltage source is electrical connected to the reactor casing, the reactor casing is electrically isolated from the reactor pipe and the conductive rod, and the reactor casing is a cathode to the electrolysis reaction.

10. The system of claim 1, wherein the negative terminal of the direct current voltage source is electrical connected to the reactor pipe and the reactor casing and the reactor pipe and the reactor casing are a cathode to the electrolysis reaction.

11. A method of electrolyzed impingement cavitation comprising:
disposing a conductive rod at least partially within a lumen of a reactor pipe comprising a plurality of beveled perforations;
disposing the conductive rod and the reactor pipe at least partially within a lumen of a reactor casing;
electrically connecting a positive terminal of a direct current voltage source to the conductive rod;
electrically connecting a negative terminal of the direct current voltage source to the reactor pipe, the reactor casing, or both the reactor pipe and the reactor casing;
applying a direct current to the conductive rod while fluidly communicating fluids into the lumen of the reactor pipe, wherein the fluids are directed out of the plurality of beveled perforations forming enhanced cavitation bubbles that impinge an inner surface of the reactor casing while in at least part of an electrolysis reaction; and
discharging fluids from an annulus formed between the reactor pipe and the reactor casing.

12. The method of claim 11, wherein the beveled perforations fluidly connect the lumen of the reactor pipe with the annulus formed between the reactor pipe and the reactor casing.

13. The method of claim 11, wherein the beveled perforations have an outer face with a bevel in a range between 40 degrees and 50 degrees to enhance cavitation.

14. The method of claim 11, wherein the enhanced cavitation bubbles are directed to collapse against an inner surface of the reactor casing with high force to enhance cavitation.

15. The method of claim 11, wherein the conductive rod is electrically isolated from the reactor pipe and the reactor casing and is an anode to the electrolysis reaction.

16. The method of claim 11, wherein the direct current voltage source has a voltage in a range between 110 volts and 220 volts.

17. The method of claim 11, wherein the direct current voltage source provides direct current to a cavitating fluids in a range between 20 amperes and 30 amperes.

18. The method of claim 11, wherein the negative terminal of the direct current voltage source is electrical connected to the reactor pipe, the reactor pipe is electrically isolated from the reactor casing and the conductive rod, and the reactor pipe is a cathode to the electrolysis reaction.

19. The method of claim 11, wherein the negative terminal of the direct current voltage source is electrical connected to the reactor casing, the reactor casing is electrically isolated from the reactor pipe and the conductive rod, and the reactor casing is a cathode to the electrolysis reaction.

20. The method of claim 11, wherein the negative terminal of the direct current voltage source is electrical connected to the reactor pipe and the reactor casing and the reactor pipe and the reactor casing are a cathode to the electrolysis reaction.
